(19) United States
(12) Patent Application Publication
(10) Pub. No.: US 2002/0065659 A1
(43) Pub. Date: May 30, 2002

(54) Speech synthesis apparatus and method

(76) Inventors: Toshiyuki Isono, Kanagawa-ken (JP); Hirofumi Nishimura, Kanagawa-ken (JP)

Correspondence Address: PEARNE & GORDON LLP, 526 SUPERIOR AVENUE EAST, SUITE 1200, CLEVELAND, OH, 44114-1484, US

(21) Appl. No.: 10/045,512

(22) Filed: Nov. 7, 2001

(30) Foreign Application Priority Data
Nov. 29, 2000 (JP) 2000-363394

(51) Int. Cl. G10L 13/08; G10L 13/00

(52) U.S. Cl. 704/260

(57) ABSTRACT

Herein disclosed a speech synthesis apparatus for and a speech synthesis method of synthesizing a speech in accordance with text data inputted therein to output a speech consisting of recorded speech portions and synthesized speech portions with reverberation properties identical to those of the recorded speech portions in which the synthesized speech portions with reverberation properties is substantially greater in the amplitude than the recorded speech portions to reduce a feeling of strangeness due to the difference in sound quality between the recorded speech portions and the synthesized speech portions.

### BACKGROUND OF THE INVENTION

1. Field of the Invention

The present invention relates to a speech synthesis apparatus for and a speech synthesis method of synthesizing a speech in accordance with text data inputted therein, and more particularly, to a speech synthesis apparatus for and a speech synthesis method of synthesizing a speech in accordance with text data inputted therein to output a speech consisting of recorded speech portions and synthesized speech portions with reverberation properties identical to those of the recorded speech portions to reduce a feeling of strangeness due to the difference in sound quality between the recorded speech portions and the synthesized speech portions.

2. Description of the Related Art

In recent years, there have been developed and used various kinds of speech synthesis apparatuses for synthesizing a speech in accordance with text data inputted therein. The speech synthesis apparatus of this type, in general, comprises a database, and is operative to divide a speech in a certain language into a plurality of speech segments each including at least one phoneme in the language, disassemble each of the speech segments into a plurality of pitch waveforms, associate the pitch waveforms with each of the speech segments, and then store each of the speech segments associated with the pitch waveforms in the database. The pitch waveforms thus stored in association with each of the speech segments in the database are used when the speech is synthesized.

On of such conventional speech synthesis apparatus is disclosed, for example, in Japanese Patent Application Laid-Open Publication No 27789/1993.

Referring to FIG. 5 of the drawing, there is shown a conventional speech synthesis apparatus 500 comprising text inputting means 501, text judging means 502, synthesizing method selecting means 503, synthesizing means 504, reproducing means 505, speech overlapping means 506, and outputting means 507.

The text inputting means 501 is adapted to input text data. The text judging means 502 is adapted to disassemble the text data, for example, “this is a pen” inputted by the text inputting means 501 into a plurality of text data elements, for example, “this”, “is”, “a”, and “pen”, and analyze each of the text data elements. The synthesizing method selecting means 503 is adapted to select a synthesizing method for each of the text data elements on the basis of the analysis made by the text judging means 502 from among a synthesizing method and a reproducing method. The synthesizing method selecting means 503 is then operated to output text data elements, for example, “a” and “pen” selected for the synthesizing method to the synthesizing means 504 and text data elements, for example, “this”, and “is” selected for the reproducing method to the reproducing means 505. The synthesizing means 504 is adapted to generate synthesized speech portions in accordance with the text data elements, i.e., “a” and “pen” inputted from the synthesizing method selecting means 503. The reproducing means 505 is adapted to reproduce recorded speech portions in accordance with the text data elements, i.e., “this” and “is” inputted from the synthesizing method selecting means 503.

The speech overlapping means 506 is adapted to input and overlap the waveforms of, the synthesized speech portions generated by the synthesizing means 504 and the recorded speech portions reproduced by the reproducing means 505 to output a speech “this is a pen” consisting of the recorded speech portions representative of “this” and “is” and the synthesized speech portions representative of “a” and “pen”. The outputting means 507 is adapted to output the speech inputted from the speech overlapping means 506 to an external device such as a speaker, not shown.

The conventional speech synthesis apparatus 500 thus constructed can synthesize a speech consisting of recorded speech portions and synthesized speech portions in accordance with text data inputted therein. Furthermore, the conventional speech synthesis apparatus 500 mentioned above in part reproduces the recorded speech portions, for example, “this” and “is”, which are recorded natural voices, thereby making it possible to synthesize a speech similar to a natural speech, which is articulate to a listener.

The conventional speech synthesis apparatus 500, however, entails such a problem that the recorded speech portions and the synthesized speech portions constituting the same speech are different in sound quality. The difference in sound quality between the recorded speech portions and the synthesized speech portions may cause a listener to be bothered by a feeling of strangeness. The larger the difference in sound quality between the recorded speech portions and the synthesized speech portions becomes, the more the listener is required to carefully listen to the speech, thereby exhausting his or her concentration on comprehending the speech.

Every natural sound has sounds persisting after the sound source has been cut off because of repeated reflections. The sounds persisting after the sound source has been cut off are hereinlater referred to as “reverberations”. The synthesized speech portions have no reverberations while, on the other hand, the recorded speech portions have reverberations. The aforesaid difference in sound quality partly results from the difference in presence or absence of reverberations between the recorded speech portions and the synthesized speech portions. This means that the difference in presence or absence of reverberations between the recorded speech portions and the synthesized speech portions may cause a listener to be bothered by a feeling of strangeness. The larger the difference becomes, the more a listener is required to carefully listen to the speech, thereby exhausting his or her concentration on comprehending the speech.

Further, the synthesized speech portions are more inarticulate than the recorded speech portions. The aforesaid difference in sound quality additionally results from the difference in articulation between the recorded speech portions and the synthesized speech portions. This means that the difference in articulation between the recorded speech portions and the synthesized speech portions may cause a listener to be bothered by a feeling of strangeness. The larger the difference becomes, the more a listener is required to carefully listen to the speech, thereby exhausting his or her concentration on comprehending the speech.

The present invention is made with a view to overcoming the previously mentioned drawback inherent to the conventional speech synthesis apparatus.

### SUMMARY OF THE INVENTION

It is therefore an object of the present invention to provide a speech synthesis apparatus for synthesizing a speech consisting of recorded speech portions and synthesized speech portions with reverberation properties identical to those of the recorded speech portions in accordance with text data inputted therein. The speech synthesis apparatus according to the present invention can synthesize a speech in which the difference in reverberations between the recorded speech portions and the synthesized speech portions is significantly reduced, thereby assisting a listener to attentively and comfortably listen to the speech.

It is another object of the present invention to provide a speech synthesis apparatus for synthesizing a speech consisting of recorded speech portions and synthesized speech portions with reverberation properties in which the synthesized speech portions with reverberation properties is substantially greater in the amplitude than the recorded speech portions. The synthesized speech portions with reverberation properties thus adjusted is improved in the articulation. This means that the speech synthesis apparatus according to the present invention can synthesize a speech in which the difference in articulation between the recorded speech portions and the synthesized speech portions is significantly reduced, thereby assisting a listener to attentively and comfortably listen to the speech.

It is a further object of the present invention to provide a speech synthesis method of synthesizing a speech consisting of recorded speech portions and synthesized speech portions with reverberation properties identical to those of the recorded speech portions in accordance with text data inputted therein. The speech synthesis method according to the present invention can synthesize a speech in which the difference in reverberations between the recorded speech portions and the synthesized speech portions is significantly reduced, thereby assisting a listener to attentively and comfortably listen to the speech.

It is a still further object of the present invention to provide a speech synthesis method of synthesizing a speech consisting of recorded speech portions and synthesized speech portions with reverberation properties in which the synthesized speech portions with reverberation properties is substantially greater in the amplitude than the recorded speech portions. The synthesized speech portions with reverberation properties thus adjusted is improved in the articulation. This means that the speech synthesis apparatus according to the present invention can synthesize a speech in which the difference in articulation between the recorded speech portions and the synthesized speech portions is significantly reduced, thereby assisting a listener to attentively and comfortably listen to the speech.

### BRIEF DESCRIPTION OF THE DRAWINGS

The features and advantages of a speech synthesis apparatus and a speech synthesis method according to the present invention will more clearly be understood from the following description taken in conjunction with the accompanying drawings in which:

FIG. 1 is a block diagram of a first embodiment of the speech synthesis apparatus 100 according to the present invention;

FIG. 2 is a flowchart showing a speech synthesis method performed by the speech synthesis apparatus 100 shown in FIG. 1;

FIG. 3 is a block diagram of a second embodiment of the speech synthesis apparatus 200 according to the present invention;

FIG. 4 is a flowchart showing a speech synthesis method performed by the speech synthesis apparatus 200 shown in FIG. 3; and

FIG. 5 is a block diagram of a conventional speech synthesis apparatus 500.

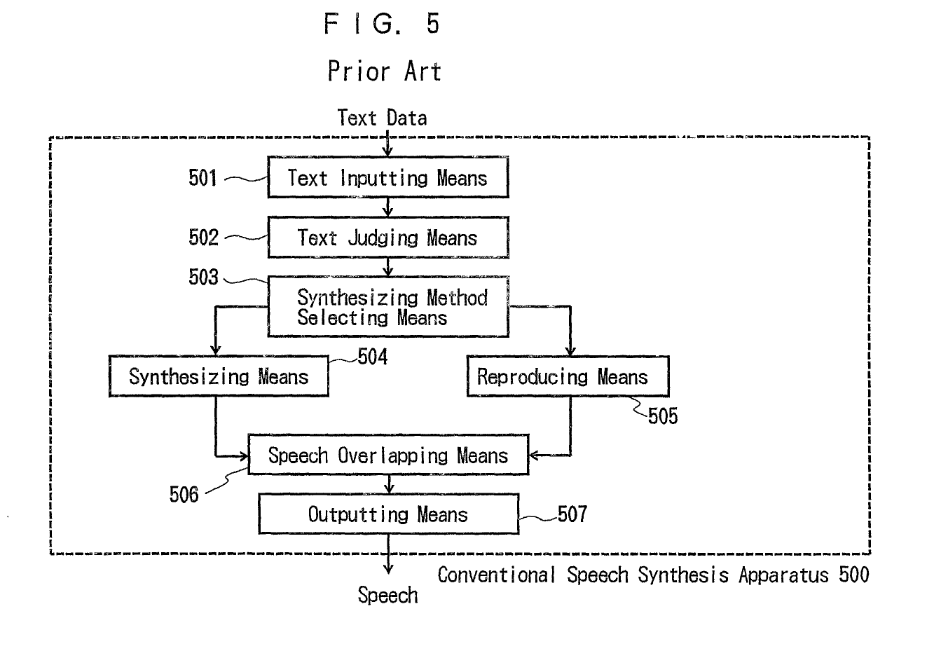

### DESCRIPTION OF THE PREFERRED EMBODIMENTS

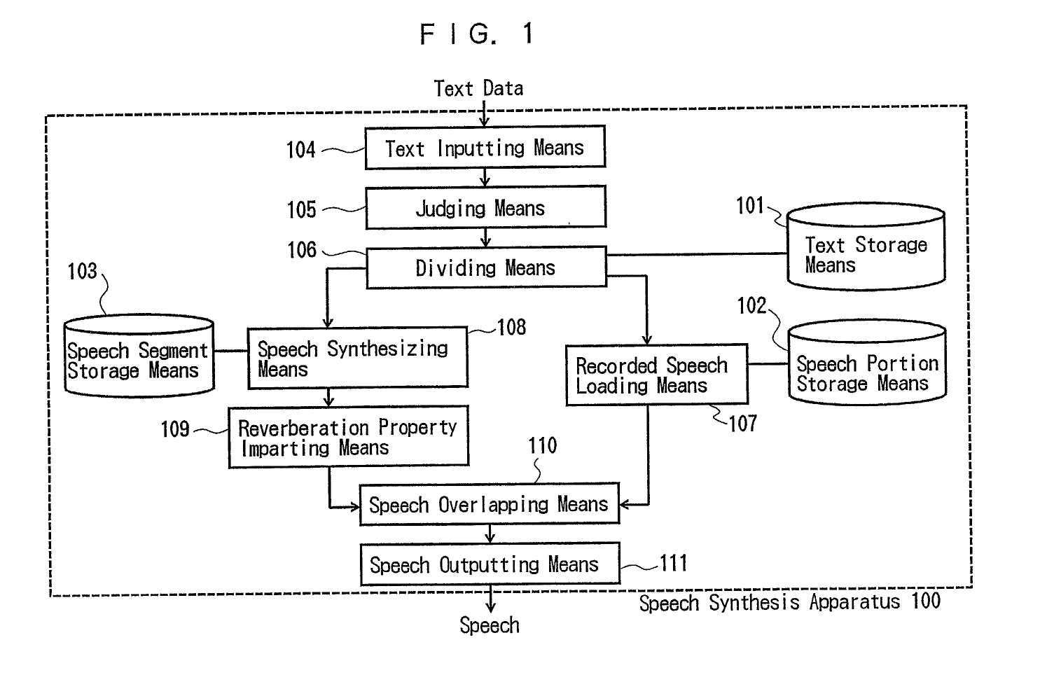

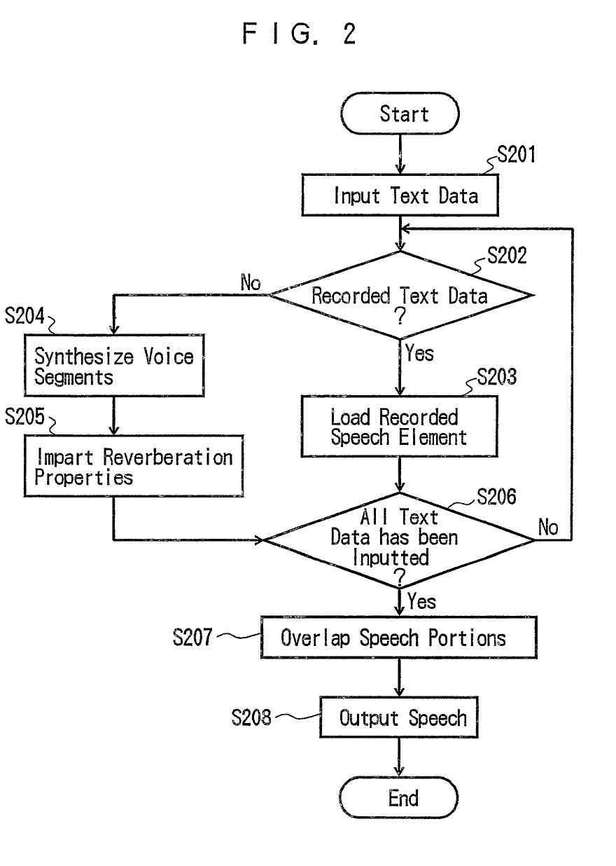

Referring to the drawings, in particular FIGS. 1 and 2, there is shown a first embodiment of the speech synthesis apparatus 100 for synthesizing a speech in accordance with text data inputted therein embodying the present invention. The first embodiment to the speech synthesis apparatus 100 thus shown in FIG. 1 comprises text storage means 101, speech portion storage means 102, speech segment storage means 103, text inputting means 104, judging means 105, dividing means 106, recorded speech loading means 107, speech synthesizing means 108, reverberation property imparting means 109, speech overlapping means 110, and speech outputting means 111.

The text storage means 101 is adapted to store a plurality of recorded text data elements therein, which will be described later. The speech portion storage means 102 is adapted to store a plurality of recorded speech portions respectively corresponding to the recorded text data elements therein. The speech segment storage means 103 is adapted to store a plurality of speech segments. Here, a speech segment is intended to mean a segment of a speech including at least one phoneme. The text inputting means 104 is adapted to input the text data.

The judging means 105 is adapted to input the text data from the text inputting means 104 and disassemble the text data into a plurality of text data elements. Here, a text data element is intended to mean a component unit of text data.

The judging means 105 is then operated to judge whether or not the text data elements are identical to any one of the recorded text data elements stored in the text storage means 101 one text data element after another. The dividing means 106 is adapted to divide the text data elements into two text portions consisting of a recorded text portion including recorded text data elements identical to the text data elements stored in the text storage means 101 and a non-recorded text portion including non-recorded text data elements identical to the text data elements not stored in the text storage means 101 on the basis of the results made by the judging means 105.

The recorded speech loading means 107 is adapted to input the recorded text portion including the recorded text data elements identical to the text data elements divided by the dividing means 106, and selectively load recorded speech portions respectively corresponding to the recorded text data elements of the recorded text portion from among recorded speech portions stored in the speech portion storage means 102.

The speech synthesizing means 108 is adapted to input the non-recorded text portion including the non-recorded text data elements identical to the text data elements divided by the dividing means 106, and synthesize the speech segments stored in the speech segment storage means 103 in accordance with the non-recorded text data elements of the non-recorded text portion to generate synthesized speech portions.

The reverberation property imparting means 109 is adapted to impart reverberation properties identical to those of the recorded speech portions stored in the speech portion storage means 102 to the synthesized speech portions generated by the speech synthesizing means 108 so as to construct synthesized speech portions with the reverberation properties.

The speech overlapping means 110 is adapted to overlap the recorded speech portions loaded by the recorded speech loading means 107 and the synthesized speech portions with the reverberation properties constructed by the reverberation property imparting means 109 to generate a speech consisting of the recorded speech portions and the synthesized speech portions with reverberation properties.

The speech outputting means 111 is adapted to output the speech consisting of the recorded speech portions and the synthesized speech portions with reverberation properties thus overlapped by the speech overlapping means 110.

The operation of the speech synthesis apparatus 100 will then be described with reference to FIG. 2.

It is assumed that the text inputting means 104 is operated to input text data, “this is a pen”, the judging means 105 is operated to disassemble the text data “this is a pen” into a plurality of text data elements, “this”, “is”, “a”, and “pen”, and the text data elements, “this” and “is” are already stored in the text storage means 101 for the purpose of simplifying the description and assisting in understanding about the whole operation of the speech synthesis apparatus 100. The text data, however, is not limited to “this is a pen”, nor are the text data elements limited to “this is a pen”, and “this”, “is”, “a”, and “pen” according to the present invention.

In the step S201, the text inputting means 104 is operated to input text data, i.e., “this is a pen”. The step S201 goes forward to the step S202 in which the judging means 105 is operated to input the text data, “this is a pen”, from the text inputting means 104 and disassemble the text data into a plurality of component units of text data elements, i.e., “this”, “is”, “a”, “pen”. The judging means 105 is then operated to judge whether or not the text data elements are identical to any one of the recorded text data elements stored in the text storage means 101 one text data element after another. In this embodiment, as mentioned above, the text data elements, “this” and “is” are stored in the text storage means 101. The judging means 105 is, therefore, operated to judge that the text data elements, “this” and “is” are identical to any one of the recorded text data elements stored in the text storage means 101. The dividing means 106 is operated to divide the text data elements, “this is a pen” into two text portions consisting of a recorded text portion including recorded text data elements identical to the text data elements, “this” and “is” stored in the text storage means 101 and a non-recorded text portion including non-recorded text data elements identical to the text data elements, “a” and “pen” not stored in the text storage means 101 on the basis of the results made by the judging means 105. This means that the recorded text data portion includes recorded text data elements, “this” and “is” and the non-recorded text data portion includes non-recorded text data elements “a” and “pen” at this stage.

The operation performed in the step S202 will be described in detail.

In the step 202, the judging means 105, for example, judges that a text data element, for example, “this” is identical to any one of the recorded text data element stored in the text storage means 101, the dividing means 106 is then operated to divide the text data element “this” into a recorded text portion including recorded text data element identical to the text data element “this” stored in the text storage means 101 on the basis of the results made by the judging means 105, and output the recorded text data element “this” to the recorded speech loading means 107.

The judging means 105, on the other hand, judges that a text data element, for example, “a” is not identical to any one of the recorded text data element stored in the text storage means 101, the dividing means 106 is then operated to divide the text data element “a” into a non-recorded text portion including non-text data element identical to text data element “a” not stored in the text storage means 101 on the basis of the results made by the judging means 105, and output the non-recorded text data element “a” to the speech synthesizing means 108.

In the step S203, the recorded speech loading means 107 is operated to input the recorded text potion including the recorded text data elements, i.e., “this” and “is” divided by the dividing means 106, and selectively load recorded speech portions respectively corresponding to the recorded text data elements, i.e., “this” and “is” of the recorded text portion from among recorded speech portions stored in the speech portion storage means 102.

In the step S204, the speech synthesizing means 108 is operated to input non-recorded text portion including the non-recorded text data elements, i.e., “a” and “pen” divided by the dividing means 106, and synthesizing the speech segments stored in the speech segment storage means 103 in accordance with the non-recorded text data elements, i.e., “a” and “pen” of the non-recorded text portion to generate synthesized speech portions.

The following description will be directed to the operation of the speech segment storage means 103 and the speech synthesizing means 108.

The speech segment storage means 103 is operative to store a plurality of speech segments each including at least one phoneme, and divisible into a plurality of pitch waveforms. In the speech segment storage means 103, the speech segments are respectively associated with the pitch waveforms with respect to the phonemes. The speech synthesizing means 108 is operated to synthesize the speech segments thus stored in the speech segment storage means 103 by superimposing the pitch waveforms associated with the speech segments with respect to the phonemes in accordance with the non-text data elements, i.e., “a” and “pen” of the non-recorded text portion divided by the dividing means 106 to generate synthesized speech portions representative of the text data elements, i.e., “a” and “pen”.

The step S204 goes forward to the step S205 in which the reverberation property imparting means 109 is operated to impart reverberation properties identical to those of the recorded speech portions stored in the speech portion storage means 102 to the synthesized speech portions generated by the speech synthesizing means 108 so as to construct synthesized speech portions with the reverberation properties. The reverberation properties are intended to mean the properties of reverberations inherent to the recorded speech portions. More particularly, the reverberation properties of the recorded speech portions stored in the speech portion storage means 102 have been measured beforehand. The reverberation property imparting means 109 is operated to impart reverberation properties identical to those of the recorded speech portions on the basis of the reverberation properties of the recorded speech portions stored in the speech portion storage means 102 thus measured beforehand, to the synthesized speech portions.

The step S203 and the step S205 go forward to the step S206 in which it is judged whether all text data has been inputted or not. According to the present invention, the judgment whether all text data has been inputted or not can be made by any appropriate constituent parts such as, for example, the speech overlapping means 110. It is, for example, judged that all text data has not yet been inputted, the step S206 returns to the step S202 and the above processed in the steps from S202 to S206 will be repeated for the remaining text data elements one text data element after another.

It is, on the other hand, judged that all text data has been inputted, the step S206 goes forward to the step S207 in which the speech overlapping means 110 is operated to overlap the recorded speech portions thus loaded by the recorded speech loading means 107 and the synthesized speech portions with the reverberation properties thus constructed by the reverberation property imparting means 109 one text data element after another to generate a speech consisting of the recorded speech portions and the synthesized speech portions with reverberation properties. According to the present invention, the speech overlapping means 110 may overlap the recorded speech portions and the synthesized speech portions by superimposing the pitch waveforms associated with the recorded speech portion and the synthesized speech portions in accordance with the text data elements.

The step S207 goes forward to the step S208 in which the speech overlapping means 110 outputs the speech consisting of the recorded speech portions and the synthesized speech portions thus overlapped to the speech outputting means 111. The speech outputting means 111 is then operated to output the speech consisting of the recorded speech portions and the synthesized speech portions with reverberation properties thus overlapped by the speech overlapping means 110 to an external device such as, for example, a speaker, not shown.

As will be seen from the foregoing description, it is to be understood that the speech synthesis apparatus 100 according to the present invention makes it possible to synthesize a speech in which the difference in reverberations between the recorded speech portions and the synthesized speech portions is significantly reduced, thereby assisting a listener to attentively and comfortably listen to the speech.

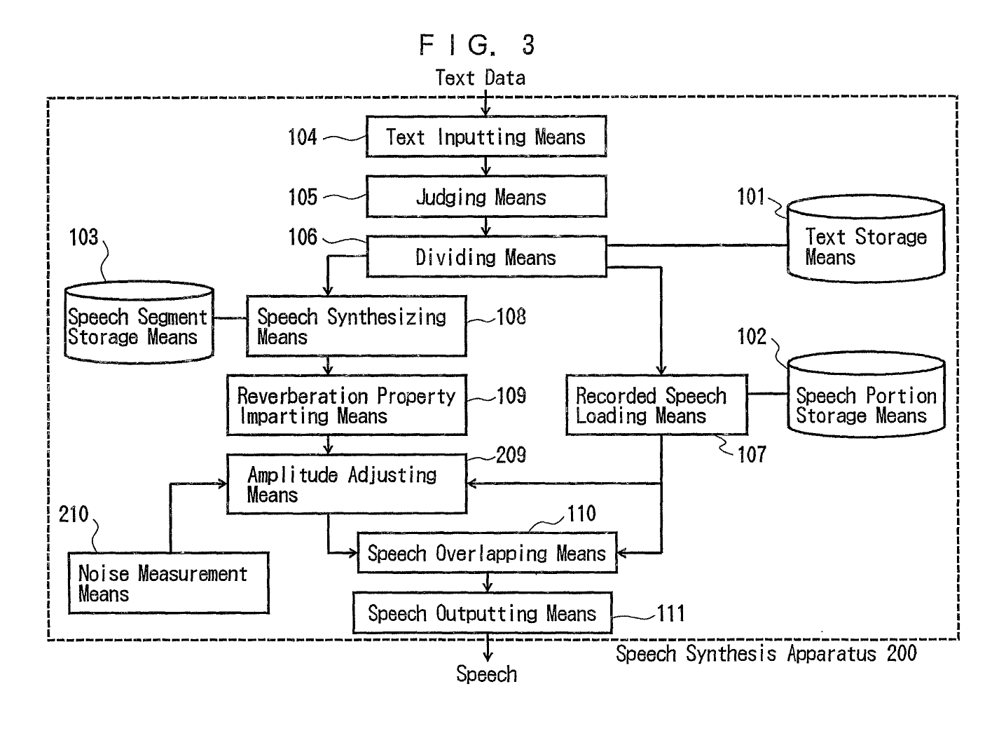

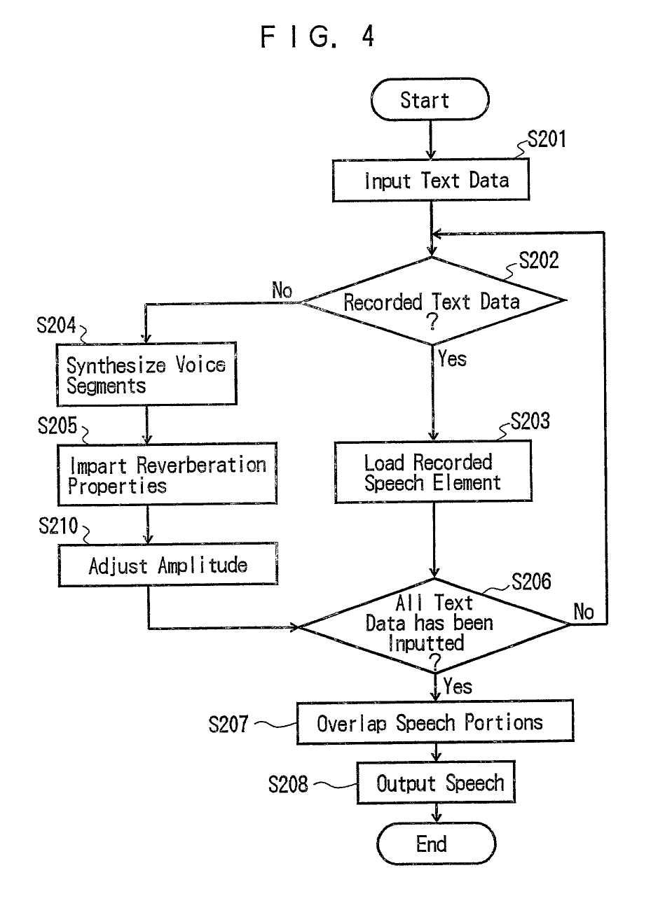

Referring to the drawings, in particular FIGS. 3 and 4, there is shown a second embodiment of the speech synthesis apparatus 200 for synthesizing a speech in accordance with text data inputted therein embodying the present invention. The second embodiment of the speech synthesis apparatus 200, as shown in FIG. 3 comprises text storage means 101, speech portion storage means 102, speech segment storage means 103, text inputting means 104, judging means 105, dividing means 106, recorded speech loading means 107, speech synthesizing means 108, reverberation property imparting means 109, noise measurement means 210, speech overlapping means 110, and speech outputting means 111. The reverberation property imparting means 109 further includes amplitude adjusting means 209.

The second embodiment of the speech synthesis apparatus 200 is almost the same in construction as the first embodiment of the speech synthesis apparatus 100 except for the amplitude adjusting means 209 and the noise measurement means 210. The parts same as the first embodiment of the speech synthesis apparatus 100 are not described in detail.

The noise measurement means 210 is adapted to measure a noise level in the environment in which the speech is audibly outputted. The amplitude adjusting means 209 is adapted to adjust the amplitude of the synthesized speech portions with the reverberation properties constructed by the reverberation property imparting means 109 on the basis of the noise level measured by the noise measurement means 210 and the amplitude of the recorded speech portions loaded by the recorded speech loading means 107 to the degree that the synthesized speech portions with the reverberation properties is substantially greater in the amplitude than the recorded speech portions in proportion to the noise level.

The operation of the speech synthesis apparatus 200 will be described in detail with reference to FIG. 4. The operation of the speech synthesis apparatus 200 is almost the same as that of speech synthesis apparatus 100 except for the step S210. The steps same as those of the speech synthesis apparatus 100 are not described in detail.

In the step S210, the noise measurement means 210 is operated to measure a noise level in the environment in which the speech is audibly outputted. The amplitude adjusting means 209 is then operated to adjust the amplitude of the synthesized speech portions with the reverberation properties constructed by the reverberation property imparting means 109 on the basis of the noise level measured by the noise measurement means 210 and the amplitude of the recorded speech portions loaded by the recorded speech loading means 107 to the degree that the synthesized speech portions with the reverberation properties is substantially greater in the amplitude than the recorded speech portions in proportion to the noise level.

The difference in articulation between the recorded speech portions and the synthesized speech portions is large if the noise level in the environment in which the speech is audibly outputted is high while, on the other hand, the difference in articulation between the recorded speech portions and the synthesized speech portions is small if the noise level in the environment in which the speech is audibly outputted is low.

This means that the amplitude adjusting means 209 is operated to increase the amplitude of the synthesized speech portions with the reverberation properties to the degree that the amplitude of the synthesized speech portions with the reverberation properties becomes much greater than that of the recorded speech portions so that the synthesized speech portions will be articulate enough for a listener to comprehend in comparison with the recorded speech portions if the noise level is high. The amplitude adjusting means 209, on the other hand, is operated to increase the amplitude of the synthesized speech portions with the reverberation properties to the degree that the amplitude of the synthesized speech portions with the reverberation properties becomes slightly greater than that of the recorded speech portions so that the synthesized speech portions will be articulate enough for a listener to comprehend in comparison with the recorded speech portions if the noise level is low.

The step S203 and the step S210 goes forward to the step S206 in which it is judged whether all text data has been inputted or not. It is, for example, judged that all text data has not yet been inputted, the step S206 returns to the steps S202 and the above processes in the steps from S202 to S206 will be repeated for the remaining text data elements one text data element after another.

It is, on the other hand, judged that all text data has been inputted, the step S206 goes forward to the step S207 in which the speech overlapping means 110 is operated to overlap the recorded speech portions thus loaded by the recorded speech loading means 107 and the synthesized speech portions with the reverberation properties thus adjusted by the amplitude adjusting means 209 one text data element after another to generate a speech consisting of the recorded speech portions and the synthesized speech portions with reverberation properties.

The step S207 goes forward to the step S208 in which the speech overlapping means 110 outputs the speech consisting of the recorded speech portions and the synthesized speech portions thus overlapped to the speech outputting means 111. The speech outputting means 111 is then operated to output the speech consisting of the recorded speech portions and the synthesized speech portions with reverberation properties thus overlapped by the speech overlapping means 110 to an external device such as, for example, a speaker, not shown.

As will be seen from the foregoing description, it is to be understood that the speech synthesis apparatus according to the present invention makes it possible to synthesize a speech in which the difference in articulation between the recorded speech portions and the synthesized speech portions is significantly reduced, thereby assisting a listener to attentively and comfortably listen to the speech.

The many features and advantages of the invention are apparent from the detailed specification, and thus it is intended by the appended claims to cover all such features and advantages of the invention which fall within the true spirit and scope thereof. Further, since numerous modifications and changes will readily occur to those skilled in the art, it is not desired to limit the invention to the exact construction and operation illustrated and described herein, and accordingly, all suitable modifications and equivalents may be construed as being encompassed within the scope of the invention.

What is claimed is:

1. A speech synthesis apparatus for synthesizing a speech in accordance with text data inputted therein, comprising:
text storage means for storing a plurality of recorded text data elements therein;
speech portion storage means for storing a plurality of recorded speech portions respectively corresponding to said recorded text data elements therein;
speech segment storage means for storing a plurality of speech segments;
text inputting means for inputting said text data;
judging means for disassembling said text data inputted by said text inputting means into a plurality of text data elements, judging whether or not said text data elements are identical to any one of said recorded text data elements stored in said text storage means one text data element after another;
dividing means for dividing said text data elements into two text portions consisting of a recorded text portion including recorded text data elements identical to said text data elements stored in said text storage means and a non-recorded text portion including non-recorded text data elements identical to said text data elements not stored in said text storage means on the basis of the results made by said judging means;
recorded speech loading means for inputting said recorded text portion including said recorded text data elements identical to said text data elements divided by said dividing means, and selectively loading recorded speech portions respectively corresponding to said recorded text data elements of said recorded text portion from among recorded speech portions stored in said speech portion storage means;
speech synthesizing means for inputting said non-recorded text portion including said non-recorded text data elements identical to said text data elements divided by said dividing means, and synthesizing said speech segments stored in said speech segment storage means in accordance with said non-recorded text data elements of said non-recorded text portion to generate synthesized speech portions;
reverberation property imparting means for imparting reverberation properties identical to those of said recorded speech portions stored in said speech portion storage means to said synthesized speech portions generated by said speech synthesizing means so as to construct synthesized speech portions with said reverberation properties;
speech overlapping means for overlapping said recorded speech portions loaded by said recorded speech loading means and said synthesized speech portions with said reverberation properties constructed by said reverberation property imparting means to generate said speech consisting of said recorded speech portions and said synthesized speech portions with reverberation properties; and
speech outputting means for outputting said speech consisting of said recorded speech portions and said synthesized speech portions with reverberation properties.

2. A speech synthesis apparatus as set forth in claim 1 further comprising noise measurement means for measuring a noise level in the environment in which said speech is audibly outputted, in which said reverberation property imparting means further includes amplitude adjusting means for adjusting the amplitude of said synthesized speech portions with said reverberation properties constructed by said reverberation property imparting means on the basis of said noise level measured by said noise measurement means and the amplitude of said recorded speech portions loaded by said recorded speech loading means to the degree that said synthesized speech portions with said reverberation properties is substantially greater in the amplitude than said recorded speech portions in proportion to said noise level;
whereby said speech overlapping means is operative to overlap said recorded speech portions loaded by said recorded speech loading means and said synthesized speech portions with said reverberation properties adjusted by said amplitude adjusting means to generate said speech consisting of said speech portions including said recorded speech portions and said synthesized speech portions with reverberation properties.

3. A speech synthesis apparatus as set forth in claim 1 or 2 in which said speech segment storage means is operative to store a plurality of speech segments each including at least one phoneme, and divisible into a plurality of pitch waveforms, said speech segments respectively associated with said pitch waveforms with respect to said phonemes, and said speech synthesizing means is operative to synthesize said speech segments stored in said speech segment storage means by superimposing said pitch waveforms associated with said speech segments with respect to said phonemes in accordance with said non-recorded text data elements of said non-recorded text portion divided by said dividing means to generate synthesized speech portions.

4. A speech synthesis method of synthesizing a speech in accordance with text data inputted therein, comprising the steps of:
(a) storing a plurality of recorded text data elements therein;
(b) storing a plurality of recorded speech portions respectively corresponding to said recorded text data elements therein;
(c) storing a plurality of speech segments;
(d) inputting said text data;
(e) disassembling said text data inputted in said step (d) into a plurality of text data elements, judging whether or not said text data elements are identical to any one of said recorded text data elements stored in said step (a) one text data element after another;
(f) dividing said text data elements into two text portions consisting of a recorded text portion including recorded text data elements identical to said text data elements stored in said step (a) and a non-recorded text portion including non-recorded text data elements identical to said text data elements not stored in said step (a) on the basis of the results made in said step (e);
(g) inputting said recorded text data portion including said recorded text data elements identical to said text data elements divided in said step (f), and selectively loading recorded speech portions respectively corresponding to said recorded text data elements of said recorded text portion from among recorded speech portions stored in said step (b);
(h) inputting said non-recorded text data portion including said non-recorded text date elements identical to said text data elements divided in said step (f), and synthesizing said speech segments stored in said step (c) in accordance with said non-recorded text data elements of said non-recorded text portion to generate synthesized speech portions;
(i) imparting reverberation properties identical to those of said recorded speech portions stored in said step (b) to said synthesized speech portions generated in said step (h) so as to construct synthesized speech portions with said reverberation properties;
(j) overlapping said recorded speech portions loaded in said step (g) and said synthesized speech portions with said reverberation properties constructed in said step
(i) to generate said speech consisting of said recorded speech portions and said synthesized speech portions with reverberation properties; and
(k) outputting said speech consisting of said recorded speech portions and said synthesized speech portions with reverberation properties.

5. A speech synthesis method as set forth in claim 4 further comprising the step of
(l) measuring a noise level in the environment in which said speech is audibly outputted, in which said step (i) further includes the step of (i-1) adjusting the amplitude of said synthesized speech portions with said reverberation properties constructed in said step (i) on the basis of said noise level measured in said step (l) and the amplitude of said recorded speech portions loaded in said step (g) to the degree that said synthesized speech portions with said reverberation properties is substantially greater in the amplitude than said recorded speech portions in proportion to said noise level;
whereby said step (j) has the step of overlapping said recorded speech portions loaded in said step (g) and said synthesized speech portions with said reverberation properties adjusted in said step (i-1) to generate said speech consisting of said speech portions including said recorded speech portions and said synthesized speech portions with reverberation properties.

6. A speech synthesis method as set forth in claim 4 or 5 in which said step (c) has the step of storing a plurality of speech segments each including at least one phoneme, and divisible into a plurality of pitch waveforms, said speech segments respectively associated with said pitch waveforms with respect to said phonemes, and said step (h) has the step of synthesizing said speech segments stored in said step (c) by superimposing said pitch waveforms associated with said speech segments with respect to said phonemes in accordance with said non-recorded text data elements of said non-recorded text portion divided in said step (f) to generate synthesized speech portions.
